(19) United States
(12) Patent Application Publication
(10) Pub. No.: US 2015/0189429 A1
(43) Pub. Date: Jul. 2, 2015

(54) METHOD AND APPARATUS FOR THE PRODUCTION OF SOUND USING A SLACKLINE

(71) Applicant: Stephen Douglas Brown, Bow, NH (US)

(72) Inventor: Stephen Douglas Brown, Bow, NH (US)

(21) Appl. No.: 14/586,611

(22) Filed: Dec. 30, 2014

Related U.S. Application Data
(60) Provisional application No. 61/922,289, filed on Dec. 31, 2013.

(51) Int. Cl. H04R 3/00; H04R 1/02

(52) U.S. Cl. CPC H04R 3/00; H04R 1/028

(57) ABSTRACT

A method and apparatus for the production of sound that may be in the form of musical tones using a slackline as the vibrational sound source and a vibrational tracking clip with an electroacoustic transducer such as a microphone, pickup or piezoelectric crystal mounted in close proximity to the slackline to transmit the vibrational sound waves from the slackline to an amplifier, a computer, tablet, mobile device, a digital recording system or other digital device and speaker to record, playback and/or modify the sound using sound effect systems and/or software applications. The present invention is further related to a vibrational inducement apparatus to induce a vibration in the slackline and tone conditioning software applications implemented on a digital device having a microprocessor, memory and storage and a measuring device that measures distance, angles, position and/or movement and translates sound signals to musical tones based on these measurements.

### RELATED APPLICATION

This application claims the benefit of pending U.S. Provisional Patent Application No. 61/922,289 filed Dec. 31, 2013 entitled METHOD AND APPARATUS FOR THE PRODUCTION OF SOUND USING A SLACKLINE which is hereby incorporated herein by reference in its entirety.

### FIELD OF THE INVENTION

The present invention is related to a method and apparatus for the production of sound that may be in the form of musical tones using a slackline as the vibrational sound source and a vibrational tracking clip that with an electroacoustic transducer such as a microphone, pickup or piezoelectric crystal mounted in close proximity to the slackline transmits the vibrational sound waves from the slackline to an amplifier, a computer, tablet, mobile device, digital recording system, or other digital device, and speaker to record, playback and/or modify the sound using one or more digital sound effects software applications or equipment. The present invention is further related to tone conditioning software applications that may adjust the tone and tonal qualities of the sound produced from the slackline using accelerometers, lasers, optical distance sensors, strain gauges, angle indicators, and other sensors and measuring devices, and sound modification circuitry and software applications to convert the vibrational sound waves produced by the slackline to musical tones that may be based on the movement, distance, deflection angle or other characteristics of the sound producing slackline. The present invention is further related to a vibrational sound induction apparatus to induce a vibration in the slackline and the adjustment of the tone and tonal qualities by jumping, tapping, plucking, or otherwise moving the slackline.

### BACKGROUND OF THE INVENTION

Slack lining is a practice in balance that typically uses nylon or polyester webbing tensioned between two anchor points such as poles or trees. Slack lining is distinct from tightrope walking in that the line is under some tension but not held rigidly taut and is instead provides dynamic bouncing like a long and narrow trampoline. The line's tension can be adjusted to suit the user's skill level and different types of webbing can be used to provide for a user to perform a number of tricks and stunts. The line itself is usually flat, due to the nature of webbing, thus keeping one's footing from rolling as would be the case with an ordinary rope. Each step or bounce results in the stretching of the webbing resulting in vibrations as the slackline in partial tension moves up and down with respect to the anchor points.

Stringed instruments make sound through the vibration of strings with the characteristics of pitch determined by the length, tension, and thickness of the string. Longer strings produce lower tones than shorter strings, tighter strings produce higher frequencies than looser strings, and thicker strings produce lower frequencies than thinner strings. The mechanism used to vibrate the string such as by plucking, bowing, or striking the string also affects the overall dynamics of the sound that is produced. By lengthening or shortening the string, different pitches are produced such as by using frets on a guitar to play different notes and produce pleasing musical tones.

The amplification of stringed instruments is well known with numerous designs of microphones, electromagnetic induction transducers, and piezoelectric devices that are mounted on or in close proximity to the vibrating string to capture, amplify and reproduce the sound emissions. Digital recording and the manipulation of tones using sounds effects is also well known, where multi-sound effect systems may be integrated to an amplifier, computer system, recording system and speaker to record, edit, and playback musical compositions created using a stringed musical instrument.

What is not known is a method and apparatus to produce sound using a slackline as the vibrational sound source from the movement and position of an individual balancing, bouncing and performing acrobatic stunts as the mechanism to vibrate the sound source and further the measurement of the movement and oscillations of the slackline in order to modify the sound produced using these measurements and tone conditioning software applications to produce musical tones as described herein in embodiments of the present invention.

### OBJECTS AND SUMMARY OF THE INVENTION

The present invention is related to the production of musical tones using a slackline as a vibrational sound source. In order to capture the sound produced from the vibration of the slackline, a vibrational tracking clip with an electroacoustic transducer such as a microphone, pickup or piezoelectric crystal is affixed on or mounted in close proximity to the slackline to transmit the vibrations as sound waves from the slackline to an amplifier, a computer, tablet, mobile device, a digital recording system or other digital device and speaker to record, play and/or modify the sound using one or more digital sound effect software applications or equipment. A series of tonal and pitch qualities may further be produced using the slackline as the vibrational sound source through using tone conditioning software applications implemented on digital devices that incorporate and transform data collected from accelerometers, ultrasonic distance sensors, lasers, strain gauges, angle indicators, and/or other sensors and measuring devices to convert the vibrational signals to musical tones and/or specific musical notes. The tone conditioning software applications may be provided on a standalone sound producing apparatus that accepts vibrational signals and/or generates musical tones that are then transformed based on data collected from the accelerometers, ultrasonic distance sensors, lasers, strain gauges, angle indicators, and/or other sensors and measuring devices. The present invention further provides a vibrational sound induction apparatus to induce a vibration in the slackline. The tone and tonal qualities of the induced vibration may then be adjusted by jumping, tapping, plucking, or otherwise moving the slackline. The adjusted induced vibration may be further modulated, modified, filtered, and otherwise enhanced and amplified using tone conditioning software applications, sound effects devices, amplifiers, and speakers.

An object of the invention is the amplification of sound waves produced by the movement of a user on a slackline.

Another object of the invention is to affix a vibrational tracking clip with an electroacoustic transducer to a point along the slackline to convert the sound produced from the vibration from the movement of a slackline to an electrical signal.

Another object of the invention is the vibrational tracking clip is of a metallic material capable of being magnetized.

Another object of the invention is the conversion of the sound produced from the vibration from the movement of a slackline to musical tones using tone conditioning software applications and/or sound effects.

Another object of the invention is to affix sensors such as accelerometers, ultrasonic distance sensors, lasers, strain gauges, angle indicators, and/or other measuring devices to obtain measurements to be used by the tone conditioning software application to convert the sound produced from the vibration from the movement of the slackline to a musical note based on the distance, movement, oscillations, and deflection angle of the slackline.

Another object of the invention is to have a standalone apparatus having sensors, measurement devices, and other electronic components that are used by the tone conditioning software application for the production of sound to develop and modify musical tones.

Another object of the invention is a vibrational sound induction apparatus to induce a vibration in the slackline and modifying the tone and tonal qualities of the induced vibration by jumping, tapping, plucking, or otherwise moving the slackline.

Another object of the invention is the modification of the induced vibration using tone conditioning software applications, sound effects devices, amplifiers, and speakers to modulate, adjust, filter, and otherwise enhance and amplify the induced vibration.

Another object of the invention is to have sound from the slackline transmitted to a digital device using Bluetooth, WiFi or another type of wireless network.

The present invention is related to an apparatus to produce sound using a slackline, comprising a vibrational tracking clip affixed to a slackline; an electroacoustic transducer having a permanent magnet, and coil; and wherein movement of the slackline causes the vibrational tracking clip to alter the magnetic flux and resonance of the permanent magnet inducing an electric current in the coil that is transmitted as an electrical signal. The apparatus to produce sound using a slackline may further comprise an amplifier and speaker to convert the electrical signal to a sound. The apparatus to produce sound using a slackline may further comprise at least one measuring device and tone conditioning software application implemented on a digital device having a microprocessor, memory and storage to transform a distance to the user on the slackline measured by the measuring device to a musical note using the tone conditioning software application. The measuring device to measure distance may be a laser, optical sensor, ultrasonic distance sensor and/or an angle indicator. The apparatus to produce sound using a slackline may further comprise at least one measuring device and tone conditioning software application implemented on a digital device having a microprocessor, memory and storage to transform the measurement of a deflection angle of the slackline as measured by the measuring device to a musical note using the tone conditioning software application. The measuring device to measure the deflection angle may be an angle indicator and/or an accelerometer. The apparatus to produce sound using a slackline may further comprise at least one measuring device and tone conditioning software application implemented on a digital device having a microprocessor, memory and storage to transform the measurement of a change in tension of the slackline as measured by the measuring device to adjust the tonal quality of a tone produced from the slackline using the tone conditioning software application. The measuring device to measure the change in tension may be a strain gauge. The apparatus to produce sound using a slackline may further comprise at least one measuring device and tone conditioning software application implemented on a digital device having a microprocessor, memory and storage to transform a movement by the user on the slackline measured by the measuring device to a musical note using the tone conditioning software application. The measuring device to measure the movement of a user on the slackline may be one or more accelerometers and/or an angle indicator. The apparatus to produce sound using a slackline may further comprise a vibrational inducement apparatus. The induced vibration of the slackline from the vibrational inducement apparatus may be modified by jumping, tapping, plucking or otherwise moving the slackline.

The present invention is further related to an apparatus to produce sound using the movement of the apparatus, comprising at least one measuring device to measure movement; a signal source; a tone conditioning software application implemented on a digital device having a microprocessor, memory and storage; and wherein tones from the signal source are transformed using the tone conditioning software application and measurements related to the movement of the apparatus measured by the measuring device. The measuring device of the apparatus to produce sound using the movement of the apparatus may be an accelerometer, a laser, an ultrasonic distance sensor, an optical sensor, and angle indicator, and/or a strain gauge.

The present invention is further related to a method of producing sound from a slackline comprising the steps of affixing a vibrational tracking clip to a slackline; affixing an electroacoustic transducer to a support of the slackline, the electroacoustic transducer having a permanent magnet and coil; moving the slackline to cause the vibrational tracking clip to alter the magnetic flux and resonance of the permanent magnet thereby inducing an electric current in the coil; transmitting the electric current as an electrical signal. The method of producing sound from a slackline may further comprise the steps of transmitting the electrical signal to an amplifier and speaker to produce a sound. The method of producing sound from a slackline may further comprise the steps of measuring the distance of the user along the slackline using a measuring device; translating the distance measurement into a musical tone using a tone conditioning software application implemented on a digital device having a microprocessor, memory and storage. The method of producing sound from a slackline may further comprise the steps of measuring the movement of the user along the slackline using a measuring device; translating the movement into a musical tone using a tone conditioning software application implemented on a digital device having a microprocessor, memory and storage.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is a perspective view of an embodiment of the sound producing apparatus using a slackline as the vibrational sound source;

FIG. 2A is a side elevation view of an embodiment of the vibrational tracking clip with the electroacoustic transducer installed in a first embodiment of the sound producing apparatus using a slackline as the vibrational sound source;

FIG. 2B is a top view of an embodiment of the vibrational tracking clip with the electroacoustic transducer installed in a first embodiment of the sound producing apparatus using a slackline as the vibrational sound source;

FIG. 3 is a front elevation view of an embodiment of the vibrational tracking clip with the electroacoustic transducer installed on a slackline in a first embodiment of the sound producing apparatus using a slackline as the vibrational sound source;

FIG. 4A is a front elevation view of an embodiment of the sound producing apparatus using a slackline as the vibrational sound source in a lower operational position;

FIG. 4B is a front elevation view of an embodiment of the sound producing apparatus using a slackline as the vibrational sound source in a higher operational position;

FIG. 5 is a block diagram of an embodiment of hardware and software components of the sound producing apparatus using a slackline as the vibrational sound source;

FIG. 6A is a perspective view of a further embodiment of the sound producing apparatus using a laser as a measuring device of the tone conditioning apparatus with the slackline as the vibrational sound source;

FIG. 6B is a perspective view of a further embodiment of the sound producing apparatus using an angle indicator as a measuring device of the tone conditioning apparatus with the slackline as the vibrational sound source;

FIG. 6C is a perspective view of a further embodiment of the sound producing apparatus using a strain gauge as a measuring device of the tone conditioning apparatus with the slackline as the vibrational sound source;

FIGS. 7A-7E are front elevation views of the further embodiment of the sound producing apparatus using a slackline as the vibrational sound source in a series of operational positions;

FIG. 8 is a diagrammatic representation of an embodiment of the tone conditioning software application implemented on a digital device in an embodiment of the sound producing apparatus using a slackline as the vibrational sound source;

FIG. 9 is a diagrammatic representation of an embodiment of a standalone tone conditioning apparatus;

FIG. 10 is a block diagram of an embodiment of components of the tone conditioning apparatus in an embodiment of the sound producing apparatus using a slackline as the vibrational sound source;

FIG. 11 is a perspective view of an embodiment of a wireless transmitter in an embodiment of the sound producing apparatus using a slackline as the vibrational sound source; and

FIG. 12 is a perspective view of an embodiment of a vibrational inducement apparatus in an embodiment of the sound producing apparatus using a slackline as the vibrational sound source.

### DETAILED DESCRIPTION OF THE INVENTION

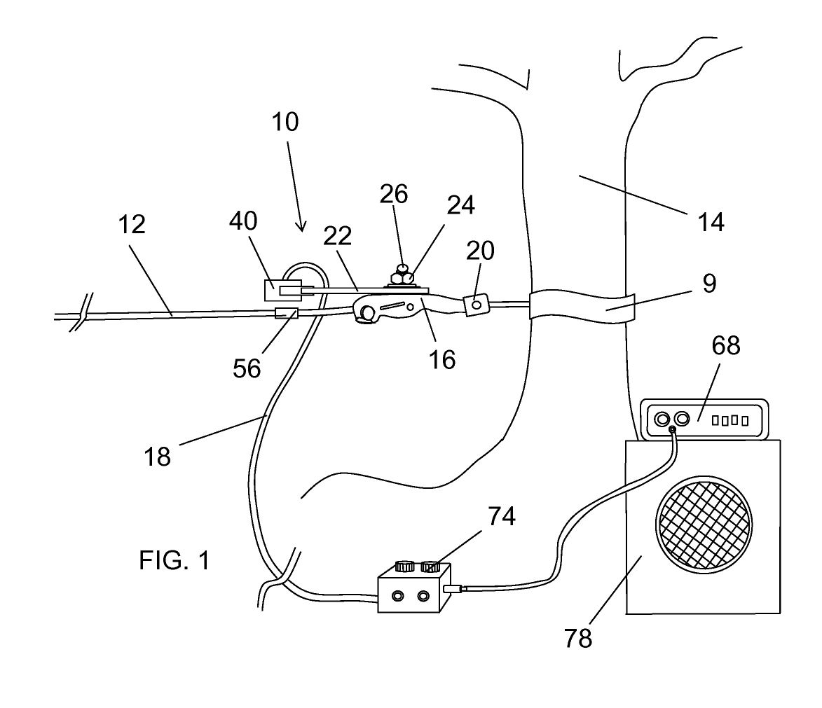

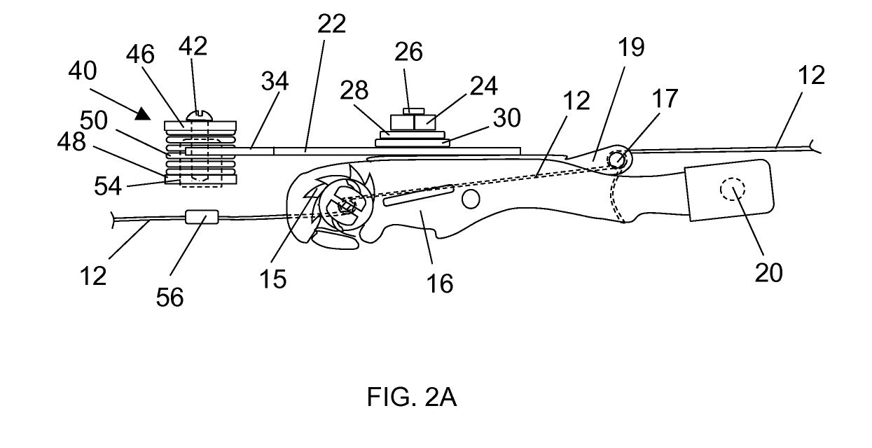

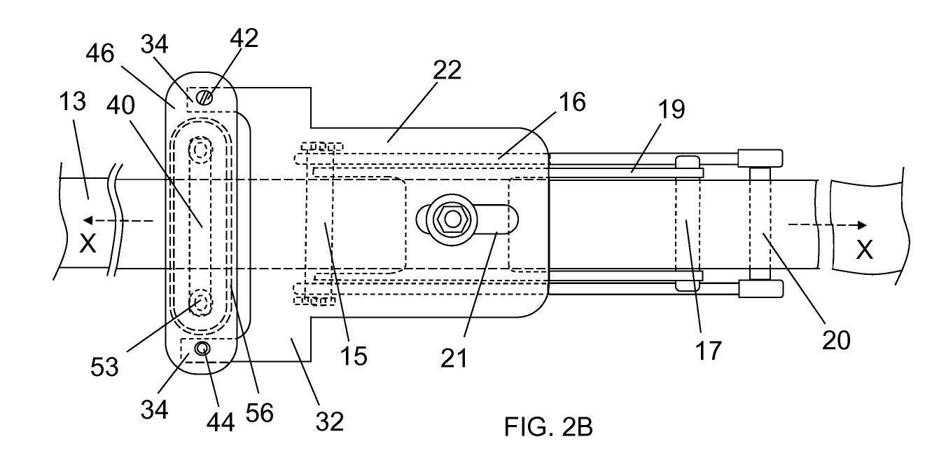

A first embodiment of the sound producing apparatus 10 using a slackline 12 as the vibrational sound source is shown in FIG. 1. A slackline 12 is anchored to two stationary ground point support structures 14 such as between two trees, two poles or other fixtures with each end of the slackline 12 attached using a ratchet 16 and tree protection pad 9. The flat webbing 13 of the slackline 12 is threaded through a spindle 17 of the ratchet 16 and the webbing 13 is tightened by a gear 15 using the handle 20 to a point of tautness in order to support the weight of a user. The spindle 17 is supported on a frame 19 that is positioned within the ratchet supports 16. On the top of the ratchet 16, a bracket 22 is attached using for example a nut 24, bolt 26, split washer 28 and washer disk 30 as shown in FIG. 2A. The bolt 26 is inserted through a slot 21 in the bracket 22 that provides for the adjustment of the position of the bracket 22 on the ratchet 16 along the axis X of the slack line 12. The bracket 22 has an extension 32 with prongs 34 as shown in FIG. 2B that provides support for a uniquely designed vibrational tracking clip 56 with an electroacoustic transducer 40. A partially threaded screw 42 is inserted through an opening 44 in an upper flange 46 of the electroacoustic transducer 40 through an opening 36 in the prong 34 of the bracket 22 and through a threaded opening 50 in the lower flange 48 to attach the electroacoustic transducer 40 to the bracket 22.

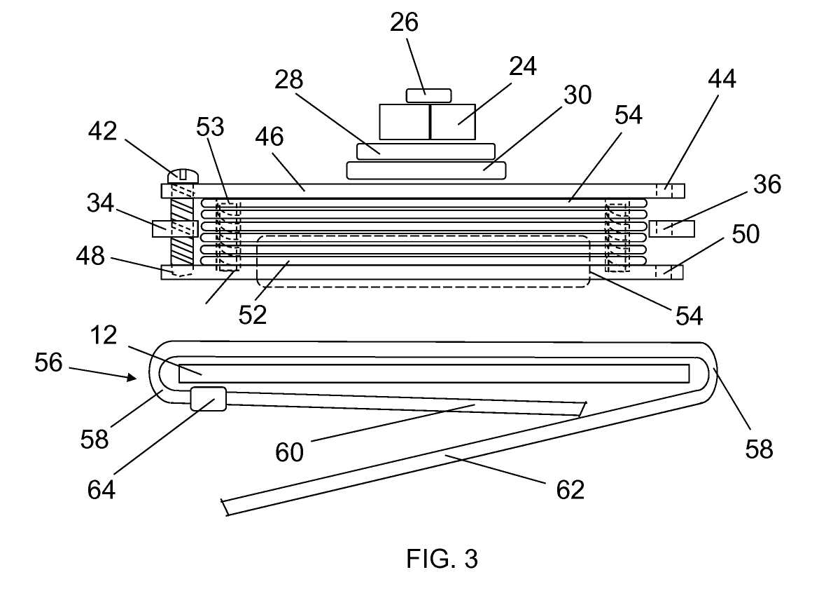

In an embodiment as shown in FIG. 3, the upper and lower flanges 46 and 48 of the electroacoustic transducer 40 support a coil 52 that surrounds a permanent magnet 54. Studs 53 may attach the coil 52 and magnet 54 to the upper and/or lower flange 46 and the coil 52 may be electrically connected through a wire 18 to a tone conditioning apparatus 67, an amplifier 68, a digital device 72 such as a laptop computer system 70, a tablet computer, iPad, iPhone, smartphone or other mobile device, a sound effects unit 74 or other electronic systems and speaker 78. An opening through the lower flange 48 provides for the magnet 54 to be positioned flush with the base of the flange 48 or extend somewhat out of the opening. The permanent magnet 54 of the electroacoustic transducer 40 is positioned in close proximity to the vibrational tracking clip 56 that is affixed around the slackline 12. In an embodiment, the vibrational tracking clip 56 is a strip of metallic material that can be magnetized or magnetic material that is formed with a first and second bend 57 and 58 along a portion of the tracking clip 56. The first bend 57 folds a first end 60 transverse to the X axis across the bottom side of the slackline 12. The second bend 58 folds a second end 62 that folds over the first end 60 and is compressed to secure the vibrational tracking clip 56 around the slackline 12. Alternatively, the first end 60 may be inserted through a clamp 64 or other fixture and then folded along the slackline 12. The second end 62 is then inserted through the clamp 64 and the clamp 64 is secured to position the vibrational tracking clip 56 directly below the permanent magnet 54. In further embodiments, the vibrational tracking clip 56 may be affixed using adhesives or other fasteners to attach the clip 56 to the slackline 12.

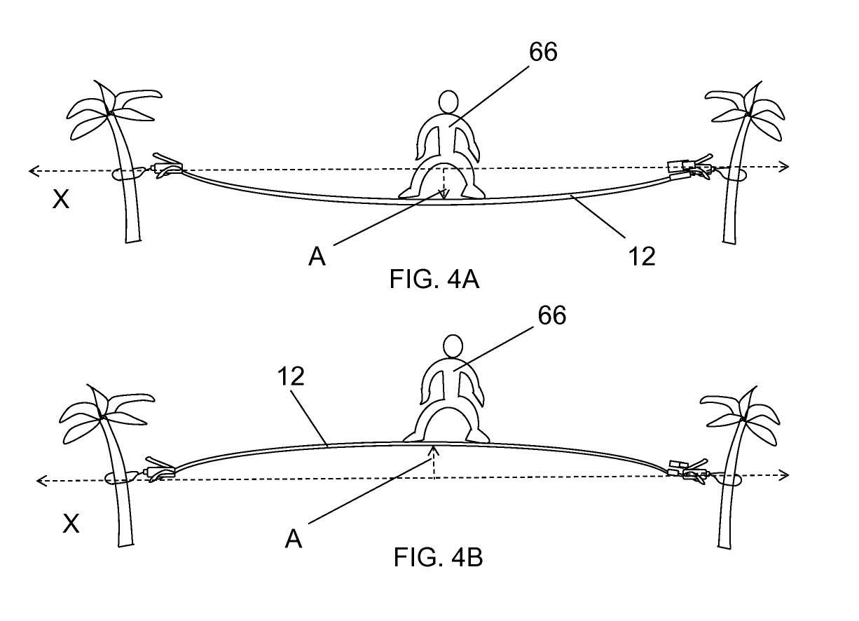

As shown in FIG. 2A, the bracket 22 is cantilevered from the ratchet 16 and provides for adjustment to move the bracket 22 along the slot 21 to position the electroacoustic transducer 40 directly over the vibrational tracking clip 56 affixed to the slackline 12. When the slackline 12 is stationary the vibrational tracking clip 56 of magnetic material passes through the concentrated non-uniform field of the permanent magnet 54 and there is a fixed or stable condition of magnetic flux and reluctance in the field. As a user 66 moves from a lower operational position with respect to the X axis as shown by the arrows in FIG. 4A to a higher operational position as shown in FIG. 4B. Through the movement of the slackline 12 by the user 66 the vibrational tracking clip 56 moves altering the stable condition of the concentrated non-uniform field varying the magnetic reluctance. The variation in the reluctance of the field induces a current in the coil 52 with the current being proportional to the characteristics of movement of the vibrational tracking clip 56 through the movement of the slackline 12.

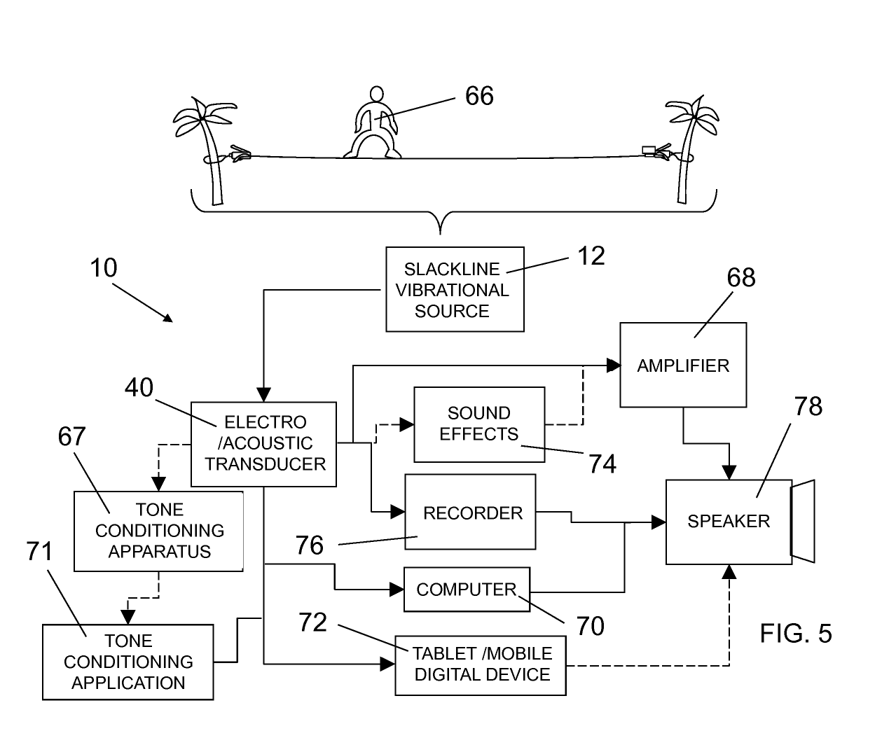

In different embodiments, as shown in FIG. 5, the sound producing apparatus 10 may have any of a number of components to play, record, and transform the sound produced from the movement of the slackline 12. The current induced in the coil is sent as an electric signal to a tone conditioning apparatus 67, an amplifier 68, a computer 70, tablet or mobile or other digital device 72, a sounds effects system 74 and/or a recording system 76 and a speaker 78, to produce sounds from the vibrational movement of the slackline 12. The tone conditioning apparatus 67, the amplifier 68, the computer 70 and/or other digital devices may have tone conditioning software applications 71 installed or accessible through a wired or wireless connection adjust the sound produced. The characteristics of the tone produced may be altered in pitch by the length, tension, and thickness of the slackline. A longer slackline will produce lower tones than a shorter slackline, a tighter slackline will produce higher frequencies than a looser slackline, and a thicker slackline will produce lower frequencies than a thinner slackline. The movement of the user in vibrating the slackline also affects the overall dynamics of the sound that is produced where louder or softer sounds are produced by the amount of force applied by the user to move the slackline.

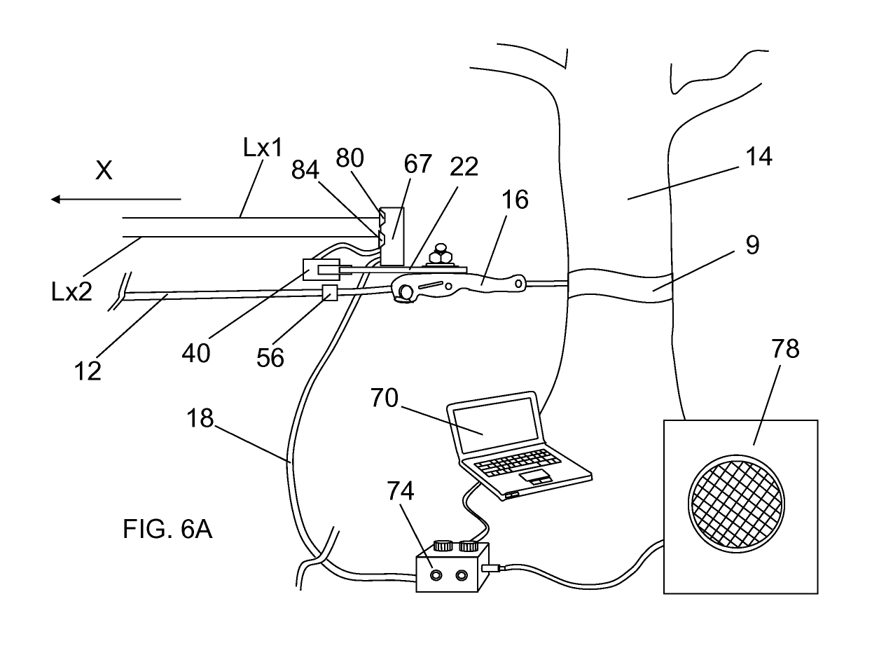

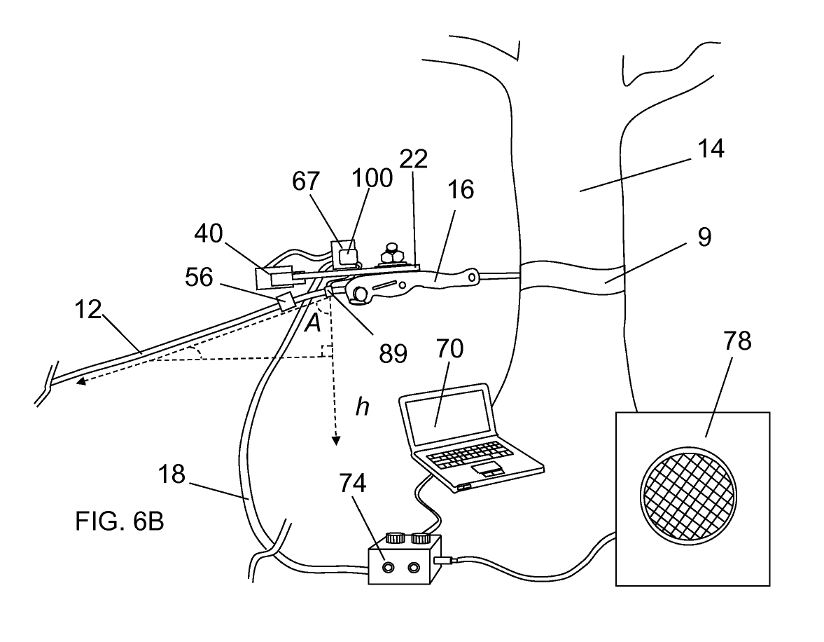

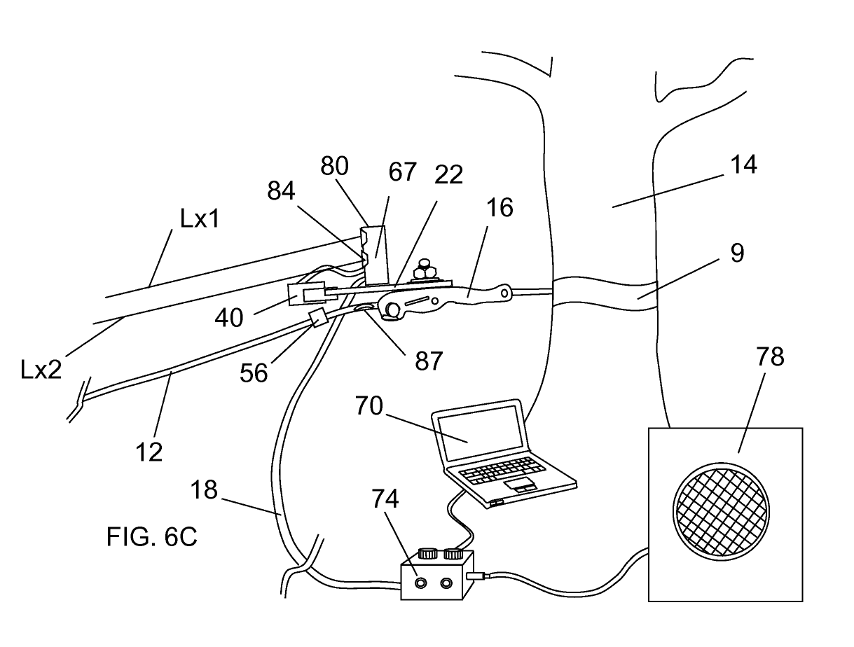

In an embodiment, the tone conditioning apparatus 67 may have one or more measuring devices such as a laser 80, an optical sensor, an ultrasonic distance sensor, an angle indicator, a strain gauge, or other sensor or measuring devices that may be installed to the bracket 22 or to the support structure 14. As shown in FIG. 6A, an emission L from the laser 80 is directed along the X axis and is reflected off of a mirror 82 positioned on the ratchet 16 at the opposing end of the slackline 12 or off of another object such as the tree or other stationary ground point as a support structure 14. The emission Lx1 is reflected back and the second emission Lx2 is directed to a receptor 84 that determines the distance of the slackline 12. The emission from the laser 80 and receiving a reflectance such as an echo is similar to other electronic signals that may be sent and received using other measuring devices such as an optical sensor or an ultrasonic distance sensor where the user may wear or hold a reflector 83, transmitter, or other sensor as required by the measuring device to identify and transmit a signal that corresponds with the user's position. The distance measured as the user's position may be used by a tone conditioning software application 71 to determine different positions of the user as different tones and/or musical notes as described herein. In further embodiments, as shown in FIG. 6B, an angle indicator 87 which may have a digital output device 89 may be attached to the slackline 12 to measure the deflection angle A during the movement of the slackline 12. A user may input either the length of the slackline 12 or the distance of the slackline 12 from the ground into the tone conditioning software application 71 to have the software calculate the position of the user from the deflection angle where a right angle triangle is formed having a first length h equal to the height of the slackline 12 from the ground and a base b along the X axis. For example, for a measured deflection angle A of 30 degrees and a height h of 3 feet, the base may be calculated as the distance 1.73 feet and the hypotenuse as 3.46 feet. The calculated distances based on a measured deflection angle A may be used to determine preset distances for musical tones similar to the adjustment in tone by the tone conditioning software 71 based on the distances measured along the X axis using the laser, optical sensors, ultrasonic distance sensors or other measuring devices. The deflection angel A may further provide frequency and amplitude information that may also be used to determine specific musical tones and/or to provide tonal qualities, loudness, softness or other dynamics to the vibrational sound signal from the slackline 12. Other measuring devices such as a strain gauge 100, as shown in FIG. 6C, may be affixed within or along the slackline 12 to measure changes in tension where these measurements may be used by the tone conditioning software application 71 to also add or adjust tonal qualities or timbre such as vibrato where rapid changes in tension may enhance the produced tone to have for example a wah wah or other sound effect.

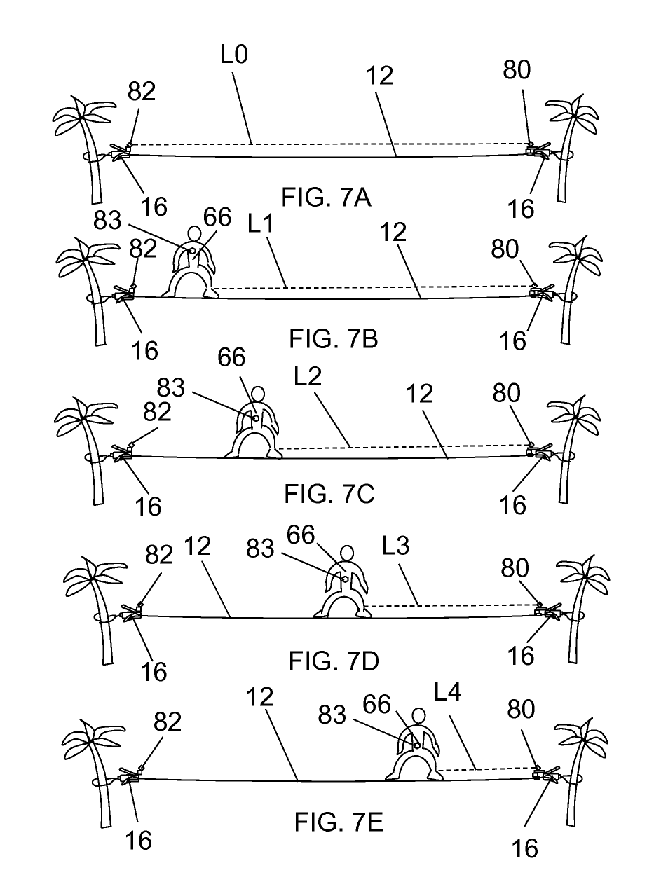

As shown in FIG. 7A, to determine the position of the user along the slackline 12, the first reflected emission LO may give the overall distance of the slackline 12. This distance data is used by the tone conditioning software application 71 of the present invention to modify the sound signal from the slackline 12 into a desired tone or specific musical note. The software application 71 may be implemented and be executable on the tone conditioning apparatus 67 and/or on a computer system 70, one or more electronic components, a tablet computer, a smartphone or on other digital devices 72 having input and output devices, display devices such as a touchscreen, microprocessors, memory and storage to transform the distance measurement into usable data to generate musical tones as described herein. For example, the LO measurement data may be used as a reference to determine the overall length of the slackline 12 or distance between the support structures 14 of the slackline 12. The emission L1 as shown in FIG. 7B is a reflection off of the user 66 and measures the distance of the user 66 along the slackline 12. As the user 66 moves along the slackline 12 the distance of the user 66 is measured as L2 in FIG. 7C, L3 in FIG. 7D, and L4 in FIG. 7E. These measurements are used as data by the tone conditioning software application 71 installed on the tone conditioning apparatus 67, on a computer system 70 or on another digital device 72 and based on the reference measurement LO the tone produced from the movement of the user 66 on the slackline 12 may be modified to create notes on a scale that as an example may have a first note at a lower pitch at the furthest distance L1 and notes at a progressively higher pitch as the user 66 moves towards the laser 80 as measured at L2, L3 and L4. Alternatively, the tone conditioning software application 71 may randomize the output from the data to produce a higher tone at one location and a much lower tone at an adjacent location. The tone conditioning software application 71 may further convert the measured distances to produce only the notes of a scale so that each adjacent location is the next note within a major or minor scale providing for a user to play a melody or a musical tune by moving along the slackline 12. For example, the reference distance LO may be divided into twelve equal sections that correspond to the twelve notes of a chromatic scale and when the user 66 is at a distance within any one of the twelve equal sections, the tone conditioning software application 71 translates this position to a note of the scale. The slackline 12 may be colored to show the black and white keys of a keyboard or the frets of a guitar so that the user may step from one key or fret to another or hit, tap or pluck to create the vibration and play music on the slackline 12.

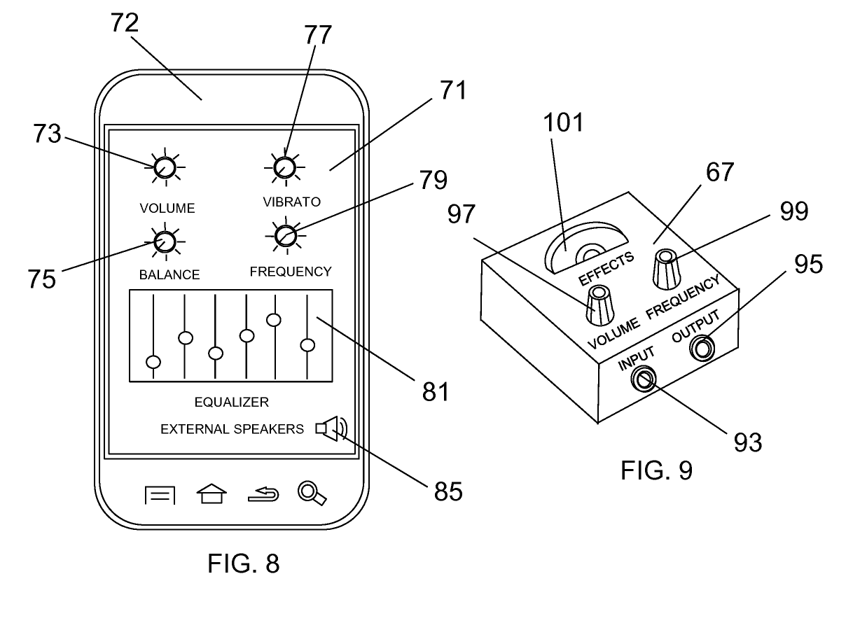

The tone conditioning software application 71 may be loaded on a digital device 72 such as a laptop computer 70, tablet computer, iPad, iPhone or mobile smartphone as shown diagrammatically in an embodiment in FIG. 8. The software application 71 may provide controls to adjust characteristics of the sound such as a volume control 73, a balance control 75 to distribute the sound between two or more speakers and a vibrato control 77 to cause a pulsating change in pitch that may use and modify measurements from the strain gauge 100 placed along the slack line 12. The vibrato control 77 may provide an adjustment to the amount of variation in pitch and the speed with which the pitch is varied. Other controls may provide for an adjustment in the frequency where the frequency control 79 may work as a filter to set specific frequency ranges or add and remove overtones and adjust the harmonics and/or the timbre of the sound signal. A user may therefore adjust the tonal qualities of the sound signal to preset values or manipulate the tonal qualities while the sound is created from the slackline 12. An equalizer 81 may also be provided to control and adjust the tonal quality of the sound signal. The sound signal may further be mixed with other musical soundtracks and adjustments with the equalizer 81 providing controls on how the sound signal from the slackline 12 mixes with other sounds. Other components and features of the tone conditioning software application 71 may provide for playing the sound through the internal speakers of the digital device or transmitting the sound to external speakers with a speaker option 85 provided for the user to select. The musical tones may be further modulated and transformed using other sound effects equipment 74.

In further embodiments, instead of distance, the note or pitch and other tonal qualities or timbre may be modified by determining the frequency, vibration, amplitude, speed and other characteristics of the moving slackline 12 using an angle indicator 87 and/or using a single axis or multi-axis accelerometer 103. The tone conditioning apparatus 67 may have an input 93 for the attachment of the apparatus 67 to the electroacoustic transducer 40 as shown in FIG. 9. An output connector 95 may provide for the apparatus 67 to be connected to an amplifier 68, speakers 78, and/or sound effects equipment 74, a computer system 70 and/or other digital devices 72. The tone conditioning apparatus 67 may have one or more controls to adjust the sound signal from the electroacoustic transducer 40 of the slackline 12 or to adjust sound signals provided to the tone conditioning apparatus 67 from other instruments.

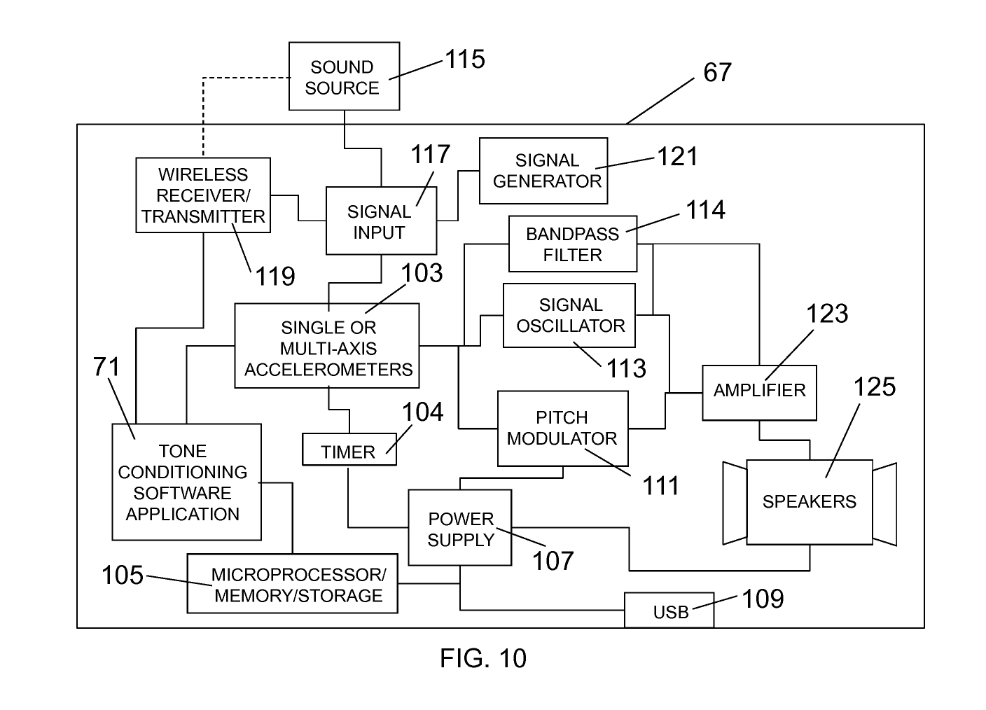

In an embodiment, a volume control 97 may set the amplitude and input level of the sound signal. A frequency control 99 may set frequency ranges or add or remove overtones to change the pitch and otherwise enhance the sound signal. An effects control 101 may be in the form of a wheel or slide to adjust and add effects to the sound signal. As shown in the block diagram of FIG. 10, the tone conditioning apparatus 67 may house the single or multi-axis accelerometers 103 and may have the tone conditioning software application 71 installed and implemented on a microprocessor, memory and storage devices 105 of the tone conditioning apparatus 67. A power supply 107 that uses rechargeable batteries or solar cells for example may be provided to power all of the components of the tone conditioning apparatus 67. Alternatively, a USB or micro USB or other connector 109 may be provided to attach a charger to recharge or power the tone conditioning apparatus 67 and/or to transmit and receive data. Any number of sound effect features such as a pitch modulation component 111, signal oscillator 113 and others may be implemented through electronics components and the tone conditioning software application 71 to modulate, modify and adjust a sound signal. The tone conditioning apparatus 67 may have other electrical and/or software components in the form of filters such as a bandpass filter 114 and/or low pass or high pass filters to remove errant, extraneous frequencies or aberrations and/or to tune the tone to particular frequencies which may be related in timbre to particular musical instruments and particular frequency ranges. In other embodiment the components for sound adjustment such as the pitch modulator 111, signal oscillator 113 and bandpass filter 114 components may be integrated as software components within the tone conditioning software application 71.

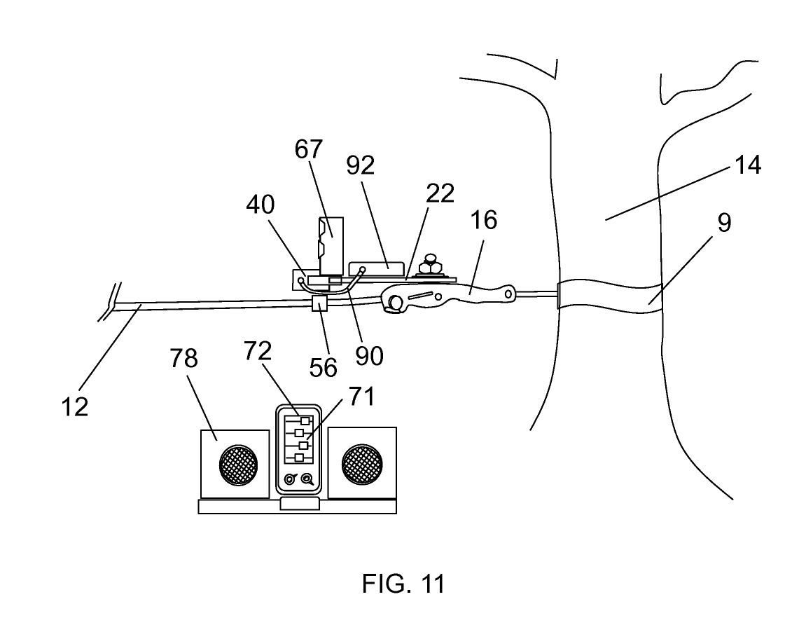

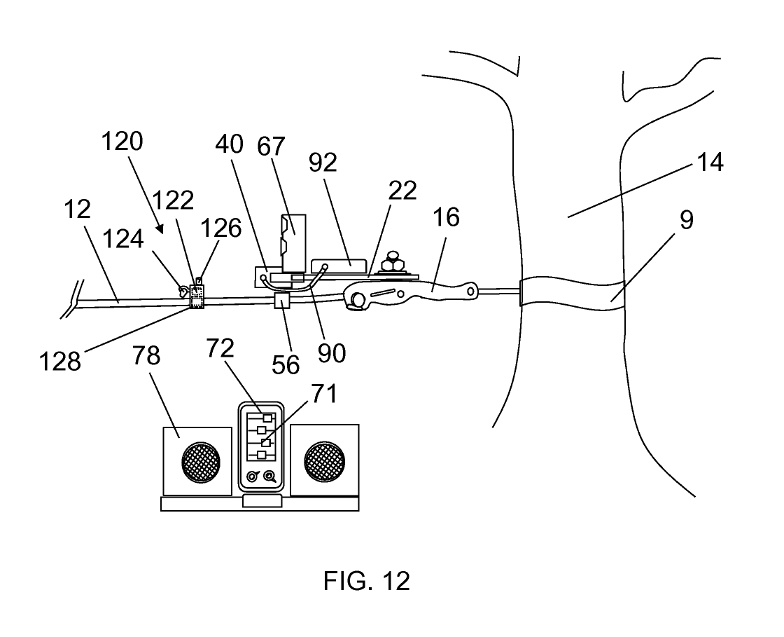

The sound source 115 may be the slackline 12 through the transmission of the sound signal from the electroacoustic transducer 40 to a signal input circuit 117 through a wired connection to the tone conditioning apparatus 67. Alternatively, the sound source 115 may be received by a wireless receiver/transmitter 119 from the electroacoustic transducer 40 that may be connected through an electrical connection 90 to a wireless transmitter 92 as shown in FIG. 11. In further embodiments, the tone conditioning apparatus 67 may have a signal generator 121 to develop sounds from the characteristics of motion measured by a single axis and/or multi-axis accelerometers 103 and/or from the measurement from the sensors and other measurement devices such as the laser 80, optical sensors, ultrasonic distance sensors, angle indicator 87 and strain gauge 100. The tone conditioning apparatus 67 may therefore be affixed to the slackline 12 without the electroacoustic transducer 40 and produce sound from the oscillating motions of the slackline 12 with as an example the tone and volume of the sound signal determined from the frequency and amplitude of the slackline 12 oscillations as measured by the angle indicator 87 and/or accelerometers 103.

The single axis and/or multi-axis accelerometers 103 may be used to translate these oscillations of the slackline 12 into characteristics of tone that may be used to modify the signal from the sound source to create musical notes within a scale and/or to produce harmonics, overtones, and effects that provide for a user to play musical tunes on the slackline 12. For example, the apparatus 67 may be mounted on the slackline 12 so that the movement of the slackline 12 creates voltage changes within the multi-axis accelerometer 103 that may correspond to movements along the X axis, side to side movements in the Y axis and up and down oscillations in the Z axis. A change in the orientation of an accelerometer in one or more axes results in changes in output voltage that may be measured. From these measurements and the simple harmonic motion of the oscillations of the slackline 12, the frequency may be calculated from the number of oscillations per second using a timer 104 and using the measured voltage changes at the transition points corresponding to changes in the direction up or down as measured by for example the Z axis accelerometer. The velocity may also be calculated from the acceleration and frequency and from the velocity, the displacement from the equilibrium position may be determined. The tone conditioning software application 71 may use these parameters to modify the pitch and tonal qualities of the vibrational signal from the slackline 12. For example, from the frequency calculation, the sound signal may be enhanced with harmonics and overtones to produce a more full pleasing tone. The frequency calculation may also be used by the pitch modulation component 111 to adjust the frequency to the same tone but within a higher or lower octave. The measured displacement and velocity of each sound signal may be used to determine relationships between tones to translate the tones using the signal oscillator 113 and other sound effect features of the tone conditioning software application 71 to convert each separate sound signal to specific tones for example as notes along a major, minor or chromatic scale. The measured displacement from the equilibrium position may further be used as an amplitude component of the sound signal that may translate to loudness, softness or other dynamic characteristics of the tone that may be integrated by the tone conditioning software 71 to the tone. Additional features of the tone conditioning software application 71 may adjust the sound signal to produce a timbre similar to a musical instrument such as an electric guitar, bass, cello, horn, or woodwind.

While the sound source may be the slackline 12, in further embodiments the sound source may be only from the signal generator 12 and/or from a musical instrument or be downloaded or accessed by the tone conditioning software application 71 through an internet connection. Additionally, multiple sound sources may be mixed together using the tone conditioning features and controls to add the sound source signal to other sounds such as rhythm or drum tracks to play or create a musical tune. In further embodiments, the tone conditioning apparatus 67 using the signal generator 121 or the wireless receiver 119 provides for the apparatus 67 to be a standalone sound generator that may have an amplifier 123 and speaker 125 to play the generated sounds. The tone conditioning software 71 transforms the motion of the apparatus 67 based on the measured acceleration, and calculated frequency, amplitude and other parameters to develop tone characteristics that may be used to enhance and modify the tones from a wired or wireless signal transmission and/or from the signal generator 121 so that a variety of sounds with distinct tonal qualities may be created simply from the movement of the tone conditioning apparatus 67. The conditioning apparatus 67 may in some embodiments be small enough to be handheld. In some embodiments, the conditioning apparatus 67 may have a protective elastic cover so that the movement by shaking, throwing, bouncing, or otherwise manipulating the device creates a range of tones that may be in the form of musical tunes.

The wireless transmitter 92 of the electroacoustic transducer 40 and the wireless receiver/transmitter 119 of the sound conditioning apparatus 67 provide for sound signals to be transmitted directly or for modified sound signals to be transmitted to a computer 70 or digital device 72 where the computer or mobile digital device 72 may be connected to speakers 78 to play the musical tones created by the movements of the user 66 and vibrations of the slackline 12 and the electroacoustic transducer 40 with the vibrational tracking clip 56 and/or from a different sound sources and/or the signal generator 121 of the tone conditioning apparatus 67.

In further embodiments, a vibration may be induced in the slackline 12 using a vibrational inducement apparatus 120. The vibrational inducement apparatus 120 may have a motor 122 that causes a mallet 124 to continuously strike the slackline 12 with sufficient force to induce the vibration. The movement of the mallet 124 may be from the rotational movement of a motor 122 or a pulsing movement by converting the rotational motor movement to an up and down movement to repeatedly strike the slackline 12. A tuning control 126 may be provided to adjust the speed and force of the mallet 124 against the slackline 12. The vibrational inducement apparatus 120 may be removably attached anywhere along the slackline 12 using a Velcro strap 128 or other attachment fixture. The induced vibration may be transmitted as an electrical signal using the vibrational tracking clip 56 and electroacoustic transducer 40. The tone and tonal qualities of the vibration may be modified by jumping on, striking, tapping, sliding a bar or object along or otherwise touching and holding the slackline 12 at different locations, thereby shortening the induced vibration causing different musical tones of lower or higher pitch based on the adjustment in length of the slackline 12. The induced vibration and modified tones and tonal qualities of the induced vibration may be input as a sound signal to the tone conditioning apparatus 67 and/or to the amplifier 68, the computer 70 and/or other digital devices 72 that may have tone conditioning software applications 71 installed or accessible through a wired or wireless connection to adjust the sound produced. The induced vibration and modified tones and tonal qualities may further be adjusted using one or more measuring devices and the tone conditioning software applications 71 as described herein.

The invention has been described in detail with particular reference to certain preferred embodiments thereof, but it will be understood that variations and modifications can be effected within the spirit and scope of the invention.

What is claimed is:

1. An apparatus to produce sound using a slackline, comprising:
a vibrational tracking clip affixed to a slackline;
an electroacoustic transducer having a permanent magnet, and coil; and
wherein movement of the slackline causes the vibrational tracking clip to alter the magnetic flux and resonance of the permanent magnet inducing an electric current in the coil that is transmitted as an electrical signal.

2. The apparatus to produce sound using a slackline of claim 1 further comprising an amplifier and speaker to convert the electrical signal to a sound.

3. The apparatus to produce sound using a slackline of claim 1 further comprising at least one measuring device and tone conditioning software application implemented on a digital device having a microprocessor, memory and storage to transform a distance to the user on the slackline measured by the measuring device to a musical note using the tone conditioning software application.

4. The apparatus to produce sound using a slackline of claim 3 wherein the at least one measuring device is one of at least a laser, an ultrasonic distance sensor, an angle indicator or an optical sensor.

5. The apparatus to produce sound using a slackline of claim 1 further comprising at least one measuring device and tone conditioning software application implemented on a digital device having a microprocessor, memory and storage to transform the measurement of a deflection angle of the slackline as measured by the measuring device to a musical note using the tone conditioning software application.

6. The apparatus to produce sound using a slackline of claim 5 wherein the at least one measuring device is one of at least an angle indicator or accelerometer.

7. The apparatus to produce sound using a slackline of claim 1 further comprising at least one measuring device and tone conditioning software application implemented on a digital device having a microprocessor, memory and storage to transform the measurement of a change in tension of the slackline as measured by the measuring device to adjust the tonal quality of a tone produced from the slackline using the tone conditioning software application.

8. The apparatus to produce sound using a slackline of claim 7 wherein the at least one measuring device is a strain gauge.

9. The apparatus to produce sound using a slackline of claim 1 further comprising at least one measuring device and tone conditioning software application implemented on a digital device having a microprocessor, memory and storage to transform a movement by the user on the slackline measured by the measuring device to a musical note using the tone conditioning software application.

10. The apparatus to produce sound using a slackline of claim 9 wherein the at least one measuring device is one of at least an angle indicator or accelerometer.

11. The apparatus to produce sound using a slackline of claim 1 further comprising a vibrational inducement apparatus.

12. The apparatus to produce sound using a slackline of claim 11 wherein tone of the induced vibration is modified by jumping, tapping, plucking or otherwise moving the slackline.

13. An apparatus to produce sound using the movement of the apparatus, comprising:
at least one measuring device to measure movement;
a signal source;
a tone conditioning software application implemented on a digital device having a microprocessor, memory and storage; and
wherein tones from the signal source are transformed using the tone conditioning software application and measurements related to the movement of the apparatus measured by the measuring device.

14. The apparatus to produce sound using the movement of the apparatus of claim 13 wherein the at least one measuring device is an accelerometer.

15. The apparatus to produce sound using the movement of the apparatus of claim 13 wherein the at least one measuring device is a laser.

16. The apparatus to produce sound using the movement of the apparatus of claim 13 wherein the at least one measuring device is an ultrasonic distance sensor.

17. The apparatus to produce sound using the movement of the apparatus of claim 13 wherein the at least one measuring device is an angle indicator.

18. A method of producing sound from a slackline comprising the steps of:
affixing a vibrational tracking clip to a slackline;
affixing an electroacoustic transducer to a support of the slackline, the electroacoustic transducer having a permanent magnet and coil;
moving the slackline to cause the vibrational tracking clip to alter the magnetic flux and resonance of the permanent magnet thereby inducing an electric current in the coil;
transmitting the electric current as an electrical signal.

19. The method of producing sound from a slackline of claim 18 further comprising the steps of:
transmitting the electrical signal to an amplifier and speaker to produce a sound.

20. The method of producing sound from a slackline of claim 18 further comprising the steps of:
measuring the distance of the user along the slackline using a measuring device;
translating the distance measurement into a musical tone using a tone conditioning software application implemented on a digital device having a microprocessor, memory and storage.

21. The method of producing a sound from the movement of a slackline of claim 18 further comprising the steps of:
measuring the movement of the user along the slackline using a measuring device;
translating the movement into a musical tone using a tone conditioning software application implemented on a digital device having a microprocessor, memory and storage.
